(19) United States
(12) Patent Application Publication
(10) Pub. No.: US 2021/0078405 A1
(43) Pub. Date: Mar. 18, 2021

(54) VEHICLE SAFETY SYSTEM

(71) Applicant: Kevin Murray, Smithers (CA)

(72) Inventor: Kevin Murray, Smithers (CA)

(21) Appl. No.: 16/569,560

(22) Filed: Sep. 12, 2019

(51) Int. Cl. B60K 28/08; H04B 17/30; B60R 7/04; E05B 83/28

(52) U.S. Cl. CPC B60K 28/08; H04B 17/30; H04M 1/0202; E05B 83/28; B60R 7/04

(57) ABSTRACT

A vehicle safety system that is mounted within a vehicle and operably coupled thereto wherein the safety system inhibits operation of the vehicle during the presence of an accessible cellular phone. The present invention includes a controller that is operably coupled to at least two operation systems of the vehicle such as but not limited to the ignition system and the transmission system. A scanner is present within the passenger cabin and is configured to detect the presence of a cellular phone. A plurality of storage compartments are mounted within the vehicle and have at least one sensor disposed therein. The storage compartments are equipped with locking mechanisms wherein the locking mechanisms are further operably coupled to the controller. The controller must receive a first signal from the sensor and second signal from the locking mechanism to permit operation of the vehicle.

### REFERENCE TO PENDING APPLICATIONS

This application does not claim the benefit of pending application.

### BACKGROUND OF THE INVENTION

### 1. Field of the Invention

The present invention relates generally to vehicle safety systems, more specifically but not by way of limitation, a vehicle safety system that is configured to communicably couple a cellular phone disposed within the passenger compartment of a vehicle and the operational controls of the vehicle wherein the safety system will inhibit operation of the vehicle until the cellular phone is locked in one of the storage compartments of the present invention.

### 2. Description of the Related Art

Cellular phones are now utilized by approximately eighty five percent of the population in North America. The proliferation of cellular phones has introduced new challenges and has resulted in numerous safety issues. As is known in the art, SMS text messaging and other forms of reciprocal communication utilizing cellular phones and the features thereof is immensely popular. The average person sends ten or more text messages a day. Individuals of a younger demographics will transmit hundreds of short video clips and text messages in a single day. As cellular phone use is this prolific, one problem has been controlling the utilization of cellular phones during operation of a motor vehicle. Thousands of deaths occur every year that are caused by distracted drivers wherein the drivers were engaged with their cellular phone while operating the vehicle. While many laws have been passed in attempt to curb the public safety hazard, the number of deaths as a result of cellular phone use during vehicle operation continues to rise.

One issue with attempting to reduce accidents caused by motor vehicle operators engaged with the cellular phones is the inability for the vehicle to operably couple with a cellular phone and in particular for engagement of the vehicle control systems. While cellular phones employ Bluetooth to communicably couple to an audio system of the vehicle for audio and cellular phone transmission, there is no ability for the cellular phone to operably couple to the operational controls of the motor vehicle so as to limit operation thereof.

Accordingly, there is a need for a vehicle safety system that is configured to provide limitation of operation of a vehicle upon detection of a cellular phone within the passenger compartment thereof until the cellular phone is placed in a compartment of the safety system.

### SUMMARY OF THE INVENTION

It is the object of the present invention to provide a vehicle safety system that inhibits operation of a motor vehicle having a cellular phone present in the passenger cabin thereof wherein the present invention includes a controller that is configured to detect and communicably couple with a cellular phone located in the passenger cabin of the vehicle.

Another object of the present invention is to provide a vehicle safety system that is operable to inhibit operation of a motor vehicle wherein the present invention provides a plurality of compartments configured to receive a cellular phone therein.

A further object of the present invention is to provide a vehicle safety system that inhibits operation of a motor vehicle having a cellular phone present in the passenger cabin thereof wherein ensuing detection of a cellular phone in the passenger cabin the cellular phone must be placed in a storage compartment of the present invention to facilitate operation of the vehicle.

Still another object of the present invention is to provide a vehicle safety system that is operable to inhibit operation of a motor vehicle wherein the storage compartments are equipped with at least one type of sensor to determine presence of a detected cellular phone.

An additional object of the present invention is to provide a vehicle safety system that inhibits operation of a motor vehicle having a cellular phone present in the passenger cabin thereof wherein the locking mechanism of the storage compartments are operably coupled to the drive controls of the vehicle.

Yet a further object of the present invention is to provide a vehicle safety system that is operable to inhibit operation of a motor vehicle wherein a detected cellular phone must be in a locked compartment in order to provide functionality of the drive controls of the vehicle.

Another object of the present invention is to a provide a vehicle safety system that inhibits operation of a motor vehicle having a cellular phone present in the passenger cabin thereof wherein present invention inhibits the vehicle being placed in gear until a detected cell phone is disposed within a storage compartment and the storage compartment is in a locked position.

An alternate object of the present invention is to provide a vehicle safety system that is operable to inhibit operation of a motor vehicle wherein the storage compartments are located in alternate positions within the passenger compartment.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWING

In drawings which illustrate embodiments of the invention wherein similar characters of reference denote corresponding parts in each view,

FIG. 1 is perspective view of an exemplary passenger cabin of a motor vehicle having the present invention disposed therein.

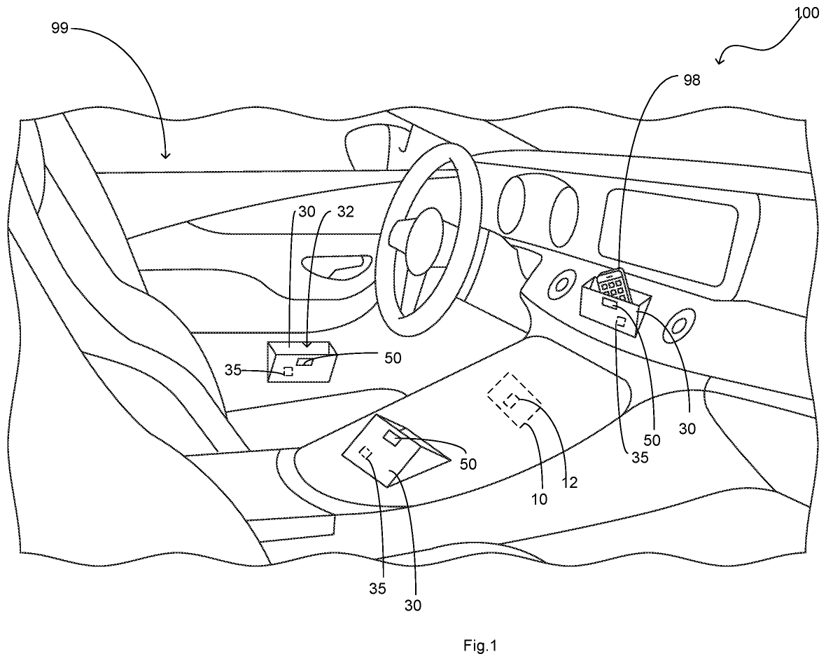

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle safety system 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the vehicle safety system 100 includes a controller 10 wherein the controller includes the necessary electronics to receive, store, transmit and manipulate data. The controller 10 is operably coupled to the plurality of storage compartments 30 and the operational controls of the vehicle. It should be understood within the scope of the present invention that the controller 10 could be configured to operably coupled with the operational controls of the vehicle in which the vehicle safety system 100 in alternate manners. By way of example but not limitation, the controller 10 could be operably coupled to the exemplary gear shifter and/or transmission so as to inhibit operation thereof in a first mode of operable coupling. A contemplated second mode of operable coupling for the controller 10 is wherein the controller 10 is communicably coupled to a central processing unit (not illustrated herein) present in the vehicle and is configured to transmit a signal to inhibit operation of the transmission or shifter. A third contemplated mode of operable coupling intermediate the controller 10 and the vehicle is wherein the controller 10 is electrically coupled to the ignition system of the vehicle and is capable of inhibiting the ignition of the vehicle until a detected phone is placed in one of the plurality of storage compartments 30. It is contemplated within the scope of the present invention that the controller 10 could be operably coupled to the various aforementioned vehicle components utilizing suitable techniques such as but not limited to wireless or wired communication protocols.

The controller 10 is configured to provide proximity monitoring of the exemplary passenger cabin 99 for a cellular phone. Ensuing detection of a cellular phone the controller 10 enters a prevention mode. In the prevention mode, the controller 10 operably communicates with one of the aforementioned components of the vehicle so as to inhibit the ability for a driver to proceed with operation of the vehicle. As previously discussed, it is contemplated within the scope of the present invention that the controller 10 could be operably coupled utilizing alternate techniques to various components of the vehicle so as to inhibit the ability to allow a driver to operate. The controller 10 includes a scanner 12 that is configured to provide detection of a cellular phone disposed within the passenger cabin 99 of the vehicle. The scanner 12 is configured to utilize at least on of the following scanning techniques in order to provide detection of a cellular phone: ferromagnetic detection, WiFi signal monitoring, Bluetooth signal monitoring or radio frequency signal monitoring.

The scanner 12 detects a cellular phone 98 within the passenger cabin 99 using the aforementioned and subsequent detection of a cellular phone will place the vehicle safety system 100 in prevention mode. In the prevention mode of the vehicle safety system 100, the controller 10 will transmit the necessary signals to at least one of the aforementioned operational elements of the vehicle so as to inhibit operation of the vehicle. In the event that multiple cellular phones are detected the controller 10 will provide a prompt to a connected graphical user interface 90 to identify that passengers in the passenger cabin are in possession of a cellular phone and as such will require only the driver place their cellular phone 98 in one of the storage compartments 30. It is also contemplated within the scope of the present invention that all cellular phones detected within the passenger cabin 99 could be required to be disposed in one of the storage compartments 30 in order to facilitate operation of the vehicle.

As illustrated herein, the vehicle safety system 100 includes a plurality of storage compartments 30. The storage compartments 30 include an interior volume 32 being of suitable size to accommodate an exemplary cellular phone 98 therein. The storage compartments 30 are illustrated herein as being hingedly coupled in various areas within the passenger cabin 99. It should be understood within the scope of the present invention that the construction of the storage compartments 30 illustrated herein are exemplary only and it is contemplated within the scope of the present invention that the storage compartments 30 could be constructed in alternate manners such as but not limited to a sliding tray configuration. It should be further understood within the scope of the present invention that the vehicle safety system 100 could employ as few as one storage compartment 30 or a multitude of storage compartments 30.

The storage compartments 30 include a sensor 35 disposed in the interior volume thereof. The sensor 35 is operably coupled to the controller 10 and is configured to transmit a signal of the presence of a cellular phone 98 within the interior volume 32 of the storage compartment 30. It is contemplated within the scope of the present invention that the sensor 35 could utilize alternate technologies to provide detection of a cellular phone 98 within the interior volume 32. By way of example but not limitation, the sensor 35 could employ infrared or weight sensing techniques. While one sensor 35 is illustrated herein, it is contemplated within the scope of the present invention that more than one sensor 35 could be provided in the storage compartments 30.

The storage compartments 30 further include a locking mechanism 50. The locking mechanism 50 is configured to provide a locked or unlocked status of the storage compartment 30. The locking mechanism 50 is operably coupled to the controller 10 so as to provide detection of the status of the storage compartment 30 having a detected cellular phone 98 disposed in the interior volume 32 thereof. A signal transmission from the sensor 35 of a cellular phone detected in the interior volume 32 and a signal status of unlocked will result in the controller 10 inhibiting operation of the vehicle utilizing techniques described herein. A signal transmission from the sensor 35 of a detected cellular phone in the interior volume 32 and a signal status of locked from the locking mechanism 50 will precipitate a signal from the controller 10 to permit operation of the vehicle. Further, in the aforementioned status, the controller 10 maintains the locking mechanism 50 in a locked status during operation of the vehicle. It is contemplated within the scope of the present invention that the locking mechanism 50 could employ alternate techniques to provide the aforementioned functionality such as but not limited to an electro-magnetic lock. While in the preferred embodiment the vehicle safety system 100 is configured for the controller 10 to receive a signal from the sensor 35 and the locking mechanism 50 in order to facilitate operation of the vehicle, it is contemplated within the scope of the present invention that the vehicle safety system 100 could be programmed so as to allow vehicle operation ensuing receipt of one of the aforementioned signals.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application, to thereby enable others skilled in the art to best utilize the present invention and various embodiments with various modifications as are suited to the particular use contemplated.

I claim:

1. A vehicle safety system installed in a vehicle that inhibits operation of a motor vehicle subsequent detection of a cellular phone disposed in the passenger cabin thereof until a first parameter and second parameter are achieved wherein the vehicle safety system comprises:
a controller, said controller being disposed in the passenger cabin of the vehicle, said controller being configured to store, receive, transmit and manipulate data, said controller being operably coupled to at least one operational system of a vehicle;
at least one storage compartment, said at least one storage compartment located in the passenger cabin of the vehicle, said at least one storage compartment having an interior volume of suitable size to accommodate a cellular phone therein;
at least one sensor, said at least one sensor being operably coupled to said controller, said at least one sensor being disposed in said at least one storage compartment, said at least one sensor configured to provide detection of a cellular phone within the interior volume of the storage compartment; and
wherein ensuing detection of a cellular phone within the interior volume of at least one storage compartment said controller transmits a signal to permit operation of the vehicle.

2. The vehicle safety system as recited in claim 1, and further including a locking mechanism, said locking mechanism being operably mounted to said at least one storage compartment, said locking mechanism being operably coupled to said controller and transmit signals thereto.

3. The vehicle safety system as recited in claim 2, and further including a scanner, said scanner being disposed within the passenger cabin of the vehicle, said scanner configured to provide detection of a cellular phone within the passenger cabin.

4. The vehicle safety system as recited in claim 3, wherein ensuing receipt of a first signal and a second signal said controller will permit operation of the vehicle.

5. The vehicle safety system as recited in claim 4, wherein said first signal is transmitted by said at least one sensor, said first signal providing indication of a cellular phone being disposed within the interior volume of said at least one storage compartment.

6. The vehicle safety system as recited in claim 5, wherein said second signal is transmitted by said locking mechanism, said second signal providing to controller a locked status of said at least one storage compartment.

7. The vehicle safety system as recited in claim 6, wherein said scanner utilizes a scanning technique that monitors for a signal selected from one of the following:
ferromagnetic, WiFi, Bluetooth or radio frequency.

8. A vehicle safety system installed in a vehicle that is configured to inhibit operation of the vehicle upon detection of an unsecured cellular phone within the passenger cabin of the vehicle wherein the vehicle safety system comprises:
a controller, said controller being disposed in the passenger cabin of the vehicle, said controller being configured to store, receive, transmit and manipulate data, said controller being operably coupled to at least two operational systems of the vehicle; and
a plurality of storage compartments, said plurality of storage compartments mounted within the passenger cabin of the vehicle in alternate locations, said plurality of storage compartments having an interior volume of suitable size to accommodate a cellular phone therein, said plurality of storage compartments having a first position and a second position, said plurality of storage compartments having at least one sensor, said at least one sensor configured to detect a cellular phone disposed in the interior volume, said at least one sensor being operably coupled to said controller,
wherein ensuing receipt of a first signal and a second signal said controller will permit operation of the vehicle.

9. The vehicle safety system as recited in claim 8, and further including a locking mechanism, said locking mechanism being operably coupled to each of said plurality of storage compartments, said locking mechanism being operably coupled to said controller.

10. The vehicle safety system as recited in claim 9, wherein said first signal is transmitted to said controller by at least one sensor disposed in one of the plurality of storage compartments, said first signal being transmitted subsequent detection of a cellular phone in the interior volume of one of said plurality of storage compartments.

11. The vehicle safety system as recited in claim 10, wherein said second signal is transmitted to said controller by said locking mechanism, said second signal being transmitted to said controller subsequent said locking mechanism being moved to a lock status.

12. The vehicle safety system as recited in claim 11, and further including a scanner, said scanner being disposed within the passenger cabin of the vehicle, said scanner operable to detect the presence of a cellular phone within the passenger cabin.

13. The vehicle safety system as recited in claim 12, and further including a graphical interface, said graphical interface being mounted within the passenger cabin, said graphical interface operably coupled to said controller.

14. The vehicle safety system as recited in claim 13, wherein said scanner utilizes a scanning technique that monitors for a signal selected from one of the following:
ferromagnetic, WiFi, Bluetooth or radio frequency.

15. A vehicle safety system installed in a vehicle that is configured detect the presence of a cellular phone in the passenger cabin of the vehicle and wherein the vehicle safety system can inhibit operation of the vehicle until the cellular phone is inaccessible wherein the vehicle safety system comprises:
a controller, said controller being disposed in the passenger cabin of the vehicle, said controller being configured to store, receive, transmit and manipulate data, said controller being operably coupled to at least two operational systems of the vehicle;
a plurality of storage compartments, said plurality of storage compartments mounted within the passenger cabin of the vehicle in alternate locations, said plurality of storage compartments having an interior volume of suitable size to accommodate a cellular phone therein, said plurality of storage compartments having a first position and a second position, said plurality of storage compartments having at least one sensor, said at least one sensor configured to detect a cellular phone disposed in the interior volume, said at least one sensor being operably coupled to said controller; and
a scanner, said scanner being disposed within the passenger cabin of the vehicle, said scanner operable to detect the presence of a cellular phone within the passenger cabin, wherein ensuing detection of a cellular phone by said scanner the controller requires receipt of a first signal and a second signal to permit operation of the vehicle.

16. The vehicle safety system as recited in claim 15, and further including a locking mechanism, said locking mechanism being operably coupled to each of said plurality of storage compartments, said locking mechanism being operably coupled to said controller, said locking mechanism configured to place the plurality of storage compartments in a locked position.

17. The vehicle safety system as recited in claim 16, wherein said first signal is transmitted to said controller by at least one sensor disposed in one of the plurality of storage compartments, said first signal being transmitted subsequent detection of a cellular phone in the interior volume of one of said plurality of storage compartments.

18. The vehicle safety system as recited in claim 17, wherein said second signal is transmitted to said controller by said locking mechanism, said second signal being transmitted to said controller subsequent said locking mechanism being moved to a lock status.

19. The vehicle safety system as recited in claim 18, wherein said at least one sensor in the plurality of storage compartments is a sensor type selected from one of the following: infrared or weight.

20. The vehicle safety system as recited in claim 19, wherein said scanner utilizes a scanning technique that monitors for a signal selected from one of the following techniques: ferromagnetic, WiFi, Bluetooth or radio frequency.
